(19) United States
(12) Patent Application Publication
(10) Pub. No.: US 2013/0085858 A1
(43) Pub. Date: Apr. 4, 2013

(54) TARGETING ADVERTISEMENTS BASED ON USER INTERACTIONS

(71) Applicants: Richard Bill Sim, Foster City, CA (US); Rong Yan, Mountain View, CA (US); Philip Anastasios Zigoris, San Francisco, CA (US)

(72) Inventors: Richard Bill Sim, Foster City, CA (US); Rong Yan, Mountain View, CA (US); Philip Anastasios Zigoris, San Francisco, CA (US)

(21) Appl. No.: 13/252,901

(22) Filed: Oct. 4, 2011

(51) Int. Cl. G06Q 30/02

(52) U.S. Cl. 705/14.58; 705/14.66

(57) ABSTRACT

In a social networking system, users may perform different types of actions with respect to objects (e.g., for a song, a user can buy, listen to, recommend, or like the song). Objects on the social networking system may include object properties (e.g., for a song, an artist, genre, and album are the song's object properties). Each type of action performed on a type of object may be aggregated in a different way. Actions may be performed on objects by users through the social networking system, a third-party application installed on the social networking system, and systems external to the social networking system. An advertiser may specify targeting criteria based on multiple different action types and aggregations of an action with respect to a particular object. Users may be categorized based on their interactions with objects having a common element. Ads may then be targeted to the categorized users.

### BACKGROUND

This invention relates generally to social networking, and in particular to targeting users of a social networking system based on their interactions with objects within and external to the social networking system.

Traditional advertisers used focus groups and demographic data to gain an understanding of how to design and implement effective ad campaigns. For example, a sports drink advertiser may use a random sampling of a target population, such as 18-35 year-old men, to determine whether an ad would be effective. However, this approach to advertising targeting may lead to inefficient ad spending because advertisements may be presented to viewers that are not interested in sports or exercise, for example.

In recent years, social networking systems have made it easier for users to share their interests and preferences in real-world concepts, such as their favorite movies, musicians, celebrities, soft drinks, hobbies, sports teams, and activities. These interests may be declared by users in user profiles and may also be inferred by social networking systems. Users can also interact with these real-world concepts through multiple communication channels on social networking systems, including interacting with pages on the social networking system, sharing interesting articles about causes and issues with other users on the social networking system, and commenting on actions generated by other users on objects external to the social networking system. Actions performed on objects by users on external websites, such as playing gaming applications, listening to music-streaming services, and reading document sharing systems, may also be captured by the social networking system. Although advertisers may target users based on interests, tools have not been developed to enable advertisers to target user interactions.

Specifically, information available on social networking systems about users' interactions with objects on the social networking system has not been made available to advertisers as targeting criteria. Because users may interact with thousands of objects within and external to the social networking system on a daily basis, enabling advertisers to target these interactions provides a valuable opportunity for advertisers that seek to drive traffic and increase engagement with their websites and brands. However, existing systems have not provided efficient mechanisms of targeting ads based on these user interactions.

### SUMMARY

In a social networking system, users may perform different types of actions with respect to objects (e.g., for a song, a user can buy, listen to, recommend, or like the song). Objects on the social networking system may include object properties (e.g., for a song, an artist, genre, and album are the song's object properties). Each type of action that is performed on a type of object may be aggregated in a different way (e.g., listened to a song 5 times, or ran an average of 10 miles per week). Actions may be performed on objects by users through the social networking system, an application installed on the social networking system developed by a third-party, as well as on systems external to the social networking system. Embodiments of the invention enable an advertiser to specify targeting criteria for an ad using rules based on multiple different action types and aggregations of an action with respect to a particular object. In one embodiment, a keyword describing a new advertisement may be used to target the advertisement to users based on multiple types of actions performed on different objects that are related to the keyword by the targeted users. In another embodiment, advertisers may customize actions that may be performed by users on objects external to the social networking system and then target ads to users that performed the customized actions. In a further embodiment, users may be categorized into interest categories based on their interactions with objects having a common element, such as technology blogs, articles, and places. Ads may be targeted to users belonging in interest categories based on keywords describing the ads matching keywords describing the interest categories.

### BRIEF DESCRIPTION OF THE DRAWINGS

FIG. 1 is high level block diagram illustrating a process of targeting advertisements to users of a social networking system based on user interactions, in accordance with an embodiment of the invention.

FIG. 2 is a network diagram of a system for targeting advertisements to users of a social networking system based on user interactions, showing a block diagram of the social networking system, in accordance with an embodiment of the invention.

FIG. 3 is high level block diagram illustrating an ad targeting module that includes various modules for targeting ads based on user interactions in a social networking system, in accordance with an embodiment of the invention.

FIG. 4 is a flowchart of a process of targeting advertisements to users of a social networking system based on user interactions, in accordance with an embodiment of the invention.

FIG. 5 is a flowchart of a process of targeting advertisements to users of a social networking system based on interest categories determined from edges associated with the users, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

A social networking system offers its users the ability to communicate and interact with other users of the social networking system. Users join the social networking system and add connections to a number of other users to whom they desire to be connected. Users of social networking system can provide information describing them which is stored as user profiles. For example, users can provide their age, gender, geographical location, education history, employment history and the like. The information provided by users may be used by the social networking system to direct information to the user. For example, the social networking system may recommend social groups, events, and potential friends to a user. A social networking system may also enable users to explicitly express interest in a concept, such as celebrities, hobbies, sports teams, books, music, and the like. These interests may be used in a myriad of ways, including targeting advertisements and personalizing the user experience on the social networking system by showing relevant stories about other users of the social networking system based on shared interests.

A social graph includes nodes connected by edges that are stored on a social networking system. Nodes include users and objects of the social networking system, such as web pages embodying concepts and entities, and edges connect the nodes. Edges represent a particular interaction between two nodes, such as when a user expresses an interest in a news article shared by another user about “America's Cup.” The social graph may record interactions between users of the social networking system as well as interactions between users and objects of the social networking system by storing information in the nodes and edges that represent these interactions. Custom graph object types and graph action types may be defined by third-party developers as well as administrators of the social networking system to define attributes of the graph objects and graph actions. For example, a graph object for a movie may have several defined object properties, such as a title, actors, directors, producers, year, and the like. A graph action type, such as “purchase,” may be used by a third-party developer on a website external to the social networking system to report custom actions performed by users of the social networking system. In this way, the social graph may be “open,” enabling third-party developers to create and use the custom graph objects and actions on external websites.

Third-party developers may enable users of the social networking system to express interest in web pages hosted on websites external to the social networking system. These web pages may be represented as page objects in the social networking system as a result of embedding a widget, a social plug-in, programmable logic or code snippet into the web pages, such as an iFrame. Any concept that can be embodied in a web page may become a node in the social graph on the social networking system in this manner. As a result, users may interact with many objects external to the social networking system that are relevant to a keyword or keyword phrase, such as “Justin Bieber.” Each of the interactions with an object may be recorded by the social networking system as an edge. By enabling advertisers to target their advertisements based on user interactions with objects related to a keyword, the advertisements may reach a more receptive audience because the users have already performed an action that is related to the advertisement. For example, a merchandiser that sells Justin Bieber t-shirts, hats, and accessories may target ads for new merchandise to users that have recently performed one of multiple different types of actions, such as listening to Justin Bieber's song “Baby,” purchasing Justin Bieber's new fragrance, “Someday,” commenting on a fan page for Justin Bieber, and attending an event on a social networking system for the launch of a new Justin Bieber concert tour. Enabling third-party developers to define custom object types and custom action types is described further in “Structured Objects and Actions on a Social Networking System,” U.S. application Ser. No. 13/239,340 filed on Sep. 21, 2011, which is hereby incorporated by reference.

A social networking system may enable advertisers to target their advertisements in different ways. A sophisticated advertiser may create and target advertisements using an application programming interface (API) that exposes the information gathered by the social networking system about edges created by users. In one embodiment, an advertiser may create an advertisement that includes within the content of the advertisement information about the edges that were created by a user that caused the ad to be targeted to that user using the API. For example, an advertisement for Jameson whiskey may be provided to a user that executed 5 check-in events at whiskey bars. The advertisement may include the 5 check-in events at whiskey bars within the content of the advertisement for Jameson whiskey.

In another embodiment, a social networking system may aggregate based on object properties, or features, for advertisement targeting criteria. For example, an advertiser may target a user based on a predetermined number of plays of any Lady Gaga song because song objects have an associated artist object as an object property of the song objects. Similarly, an advertiser may target a user based on a predetermined number of plays of any song within a certain genre, such as Pop music, because song objects are associated with genre objects. Additionally, an advertiser may target users that have listened to songs that include the word “Dance” in the title of the song, such as Lady Gaga's song, “Just Dance,” and Whitney Houston's song, “I Wanna Dance with Somebody.” The title of a song is another object property that may be aggregated and used for targeting criteria of advertisements. A social networking system may also enable advertisers to specify aggregations on multiple different types of actions, such as a predetermined number of plays of a song and at least one previous check-in at a concert hall. In short, objects in the social networking system have metadata associated with the objects that vary based on the type of object. A social networking system may enable advertisers to target aggregations of these object properties, or features of objects.

As another example, less sophisticated advertisers, such as small business owners, may create and target advertisements through a user interface in the social networking system. Using the user interface, advertisers may input keywords that describe the advertisement and select edge types, or types of actions that may be performed by users of the social networking system. Keywords and edge types received by the social networking system may then be used to retrieve edges of the selected edge types that are associated with the keywords.

In one embodiment, targeting criteria for an advertisement may include a predetermined threshold number of actions of a particular action type that must be performed by a user in order to be targeted by the advertisement. In another embodiment, targeting criteria for an advertisement may include an interest category that has been defined and associated with users of the social networking system based on their interactions. An interest category may be defined by administrators of the social networking system or advertisers to include a set of rules. Such rules may include keywords, edge types, and predetermined thresholds. For example, a “nightlife” interest category may be associated with users of the social networking system that have checked-in to multiple bars after 6 p.m. Machine learning and regression analysis may be used in determining thresholds in the definitions of the interest categories, in one embodiment.

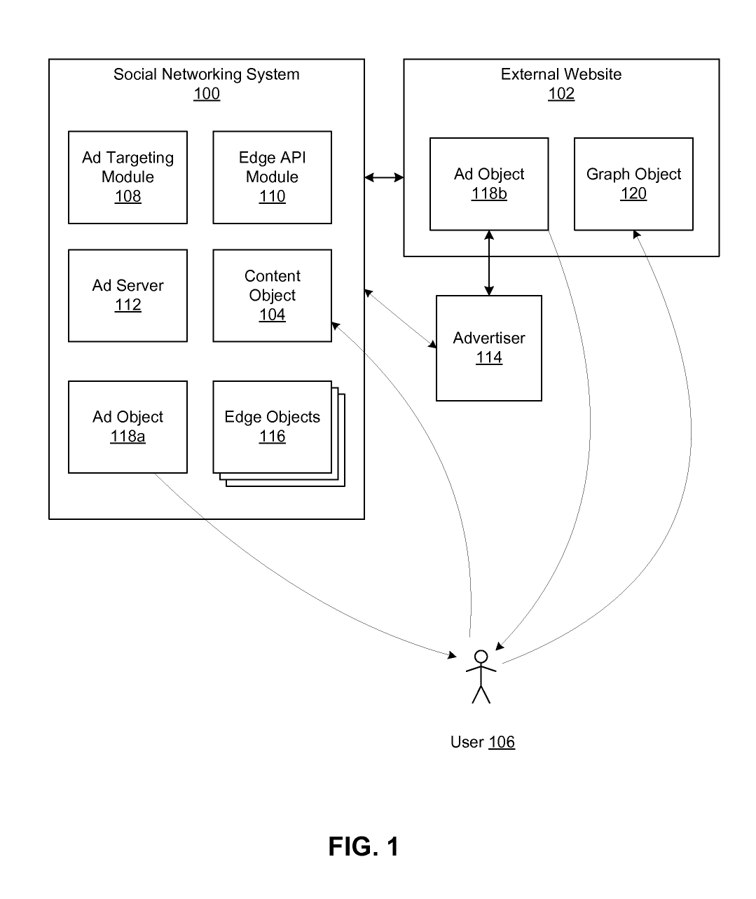

FIG. 1 illustrates a high level block diagram of a process of targeting advertisements to users of a social networking system based on user interactions, in one embodiment. The social networking system 100 may be communicatively coupled to an external website 102 through a social plug-in, or widget. A content object 104 on the social networking system 100 may be acted upon by a user 106 of the social networking system 100. The content object 104 may include any type of object on the social networking system 100, such as a page post, a status update, a photo, a video, a link, a shared content item, a gaming application achievement, a check-in event at a local business, and so on. The interaction between the user 106 and the content object 104 generates an edge object 116 that includes information about the interaction, including identifying information about the user 106, the content object 104, and the type of action that was performed. In one embodiment, the content object 104 on the social networking system 100 may be acted upon by a user 106 of the social networking system 100 through a specific application installed on the social networking system 100.

An ad targeting module 108 may receive targeting information for advertisements from an advertiser 114, such as targeting criteria that includes an edge type and a keyword. An ad object 118a may be generated by the ad targeting module 108 and provided to a user 106 by an ad server 112. A sophisticated advertiser 114 may use an edge API module 110 to provide targeting criteria to the ad targeting module 108. In another embodiment, the social networking system 100 may provide a user interface to an advertiser 114 to select targeting criteria for the ad targeting module 108.

FIG. 1 and the other figures use like reference numerals to identify like elements. A letter after a reference numeral, such as “118a,” indicates that the text refers specifically to the element having that particular reference numeral. A reference numeral in the text without a following letter, such as “118,” refers to any or all of the elements in the figures bearing that reference numeral (e.g. “118” in the text refers to reference numerals “118a” and/or “118b” in the figures). Only two ad objects 118 are shown in FIG. 1 in order to simplify and clarify the description.

An external website 102 may include a graph object 120 that a user 106 may act upon. An interaction between the user 106 and the graph object 120 may be communicated to the social networking system 100 via a social plug-in, widget, or code snippet. The interaction may then be reported to an advertiser 114 who may modify an ad object 118b that is provided to the user 106. For example, a user 106 may execute a “play” action of a song by Justin Bieber, “One more time,” which may be captured as a graph object 120. The interaction between the user 106 and the graph object 120 may be reported to the social networking system 100. The advertiser 114 may be informed of the interaction and may modify an ad object 118b on the external website 102 to include advertisements based on the interaction. In one embodiment, the external website 102 may update the rendering of the ad object 118b in real-time based on the received interaction between the user 106 and the graph object 120 because the advertiser 114 may include in the ad object 118b programmable logic that updates the advertisement in real-time responsive to interactions with the graph object 120. Further, the social networking system 100 may update a rendering of an ad object 118a in real-time based on the received interaction between the user 106 and the graph object 120, such as updating an aggregated count of interactions by the user.

Using the above methods, a social networking system may enable advertisers to target their advertisements to users of the social networking system based on interactions captured by the social networking system. These interactions may occur within the social networking system, such as interactions with other users of the social networking system via messages, wall posts, and comments, application interactions, and other interactions with objects on the social networking system, such as uploading videos and photos and interacting with gaming applications on the social networking system. User interactions may also be performed external to the social networking system, such as completing a running workout, finishing a road trip across the country, and playing songs on a playlist. In one embodiment, an advertiser may target specific applications through which actions were performed on object by users of the social networking system 100. These interactions, captured by the social networking system as custom objects and custom actions in a custom social graph, may also be used by advertisers for targeting purposes.

### System Architecture

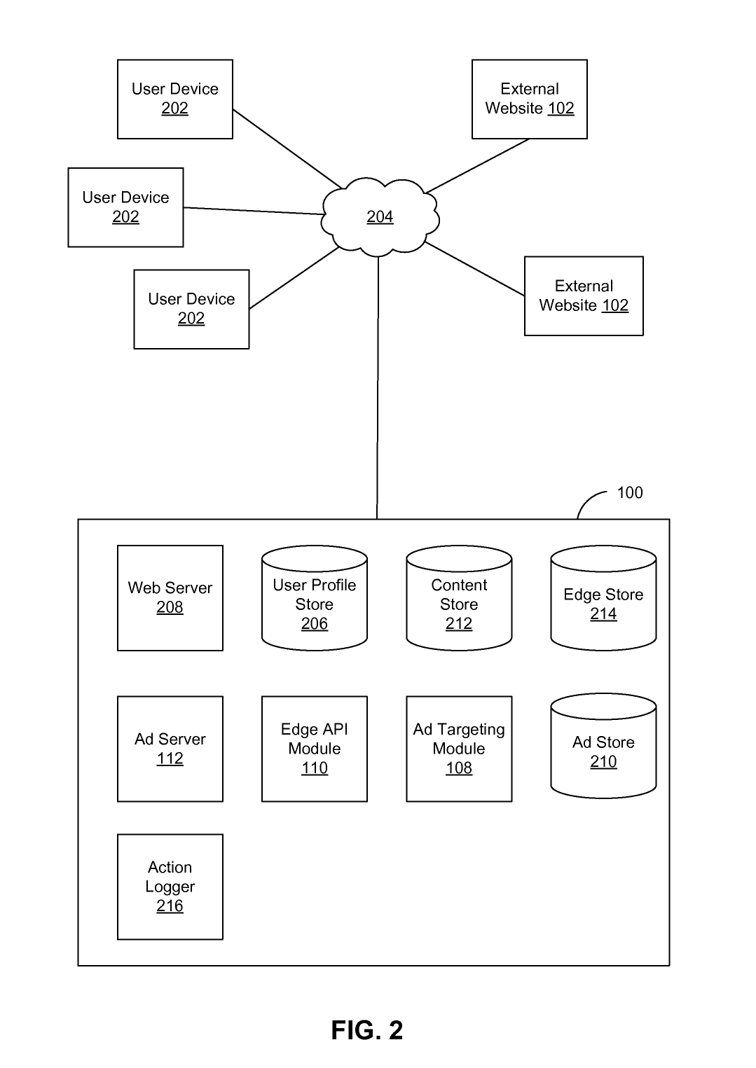

FIG. 2 is a high level block diagram illustrating a system environment suitable for enabling preference portability for users of a social networking system, in accordance with an embodiment of the invention. The system environment comprises one or more user devices 202, the social networking system 100, a network 204, and external websites 102. In alternative configurations, different and/or additional modules can be included in the system.

The user devices 202 comprise one or more computing devices that can receive user input and can transmit and receive data via the network 204. In one embodiment, the user device 202 is a conventional computer system executing, for example, a Microsoft Windows-compatible operating system (OS), Apple OS X, and/or a Linux distribution. In another embodiment, the user device 202 can be a device having computer functionality, such as a personal digital assistant (PDA), mobile telephone, smart-phone, etc. The user device 202 is configured to communicate via network 204. The user device 202 can execute an application, for example, a browser application that allows a user of the user device 202 to interact with the social networking system 100. In another embodiment, the user device 202 interacts with the social networking system 100 through an application programming interface (API) that runs on the native operating system of the user device 202, such as iOS 4 and ANDROID.

In one embodiment, the network 204 uses standard communications technologies and/or protocols. Thus, the network 204 can include links using technologies such as Ethernet, 802.11, worldwide interoperability for microwave access (WiMAX), 3G, 4G, CDMA, digital subscriber line (DSL), etc. Similarly, the networking protocols used on the network 204 can include multiprotocol label switching (MPLS), the transmission control protocol/Internet protocol (TCP/IP), the User Datagram Protocol (UDP), the hypertext transport protocol (HTTP), the simple mail transfer protocol (SMTP), and the file transfer protocol (FTP). The data exchanged over the network 204 can be represented using technologies and/or formats including the hypertext markup language (HTML) and the extensible markup language (XML). In addition, all or some of links can be encrypted using conventional encryption technologies such as secure sockets layer (SSL), transport layer security (TLS), and Internet Protocol security (IPsec).

FIG. 2 contains a block diagram of the social networking system 100. The social networking system 100 includes an ad targeting module 108, an edge API module 110, an ad server 112, a user profile store 206, a web server 208, an ad store 210, a content store 212, an edge store 214, and an action logger 216. In other embodiments, the social networking system 100 may include additional, fewer, or different modules for various applications. Conventional components such as network interfaces, security functions, load balancers, failover servers, management and network operations consoles, and the like are not shown so as to not obscure the details of the system.

The web server 208 links the social networking system 100 via the network 204 to one or more user devices 202; the web server 208 serves web pages, as well as other web-related content, such as Java, Flash, XML, and so forth. The web server 208 may provide the functionality of receiving and routing messages between the social networking system 100 and the user devices 202, for example, instant messages, queued messages (e.g., email), text and SMS (short message service) messages, or messages sent using any other suitable messaging technique. The user can send a request to the web server 208 to upload information, for example, images or videos that are stored in the content store 212. Additionally, the web server 208 may provide API functionality to send data directly to native user device operating systems, such as iOS, ANDROID, webOS, and RIM.

An ad server 112 serves advertisements, embodied in ad objects 118 stored in the ad store 210, to users of the social networking system 100. In one embodiment, the ad server 112 may serve advertisements to external websites 102 based on targeting criteria received via the ad targeting module 108. In another embodiment, the ad server 112 serves advertisements that include content items posted by users of the social networking system 100 that are sponsored by an advertiser. For example, a user may create a check-in event at a Starbucks Coffee shop in San Francisco, Calif. that is shared with other users connected to the user. An advertiser for Starbucks may highlight that check-in event in the other users' feeds by creating an advertisement based on the check-in event that is targeted to the other users connected to the user.

An edge API module 110 responds to application programming interface (API) calls for interaction information of users of the social networking system 100. In one embodiment, the edge API module 110 responds to requests for a specific node in the social networking system 100 and edges related to that node. For example, an advertiser for an online music streaming service may wish to identify user interactions related to Justin Bieber. As a result, the advertiser for the online music streaming service may make an API call requesting this information, specifying the custom artist object as Justin Bieber. The edge API module 110 may respond with the user interaction information in a format requested by the online music streaming website, in one embodiment. In another embodiment, the edge API module 110 responds to a request for edge information about a specified node with a listing of edge information about user interactions with the specified node, including the edge type and information about the user. Sophisticated advertisers may customize API calls to filter the user interaction information, such as including demographic filters, location filters, and the like.

In a further embodiment, the edge API module 110 responds to requests for user interactions having specific action types and object properties. For example, an advertiser for a new action movie may want to target users of the social networking system that have recently watched action movies. Targeting criteria may include a time period, such as the past 28 days, the past 7 days, and the past 24 hours, during which edge objects were generated. The advertiser for the movie may make API calls to the social networking system 100 requesting edge objects that include a “watch” action and objects having an “action” genre as an object property. The edge API module 110 responds to the API calls with the requested information. In yet another embodiment, the edge API module 110 may receive an API call that requests edge information about multiple types of edges of actions performed on objects having a common object property. For example, an advertiser for Starbucks may wish to target users of the social networking system that have performed any kind of action at a Starbucks location, such as reading, drinking, being at, and the like. Specific Starbucks stores may have separate nodes on the social networking system, but share common object properties of being affiliated with Starbucks and being coffee shops. As a result, a number of API calls may be received that include the multiple action types and multiple object properties.

The action logger 216 is capable of receiving communications from the web server 208 about user actions on and/or off the social networking system 100. The action logger 216 populates an action log with information about user actions to track them. Such actions may include, for example, adding a connection to the other user, sending a message to the other user, uploading an image, reading a message from the other user, viewing content associated with the other user, attending an event posted by another user, among others. In addition, a number of actions described in connection with other objects are directed at particular users, so these actions are associated with those users as well.

An action log may be used by a social networking system 100 to track users' actions on the social networking system 100 as well as external websites that communication information back to the social networking system 100. As mentioned above, users may interact with various objects on the social networking system 100, including commenting on posts, sharing links, and checking-in to physical locations via a mobile device. The action log may also include user actions on external websites. For example, an e-commerce website that primarily sells luxury shoes at bargain prices may recognize a user of a social networking system 100 through social plug-ins that enable the e-commerce website to identify the user of the social networking system. Because users of the social networking system 100 are uniquely identifiable, e-commerce websites, such as this luxury shoe reseller, may use the information about these users as they visit their websites. The action log records data about these users, including viewing histories, advertisements that were clicked on, purchasing activity, and buying patterns.

User account information and other related information for a user are stored in the user profile store 206. The user profile information stored in user profile store 206 describes the users of the social networking system 100, including biographic, demographic, and other types of descriptive information, such as work experience, educational history, gender, hobbies or preferences, location, and the like. The user profile may also store other information provided by the user, for example, images or videos. In certain embodiments, images of users may be tagged with identification information of users of the social networking system 100 displayed in an image. The user profile store 206 also maintains references to the actions stored in an action log and performed on objects in the content store 212.

The edge store 214 stores the information describing connections between users and other objects on the social networking system 100. Some edges may be defined by users, allowing users to specify their relationships with other users. For example, users may generate edges with other users that parallel the users' real-life relationships, such as friends, co-workers, partners, and so forth. Other edges are generated when users interact with objects in the social networking system 100, such as expressing interest in a page on the social networking system, sharing a link with other users of the social networking system, and commenting on posts made by other users of the social networking system. The edge store 214 stores edge objects that include information about the edge, such as affinity scores for objects, interests, and other users. Affinity scores may be computed by the social networking system 100 over time to approximate a user's affinity for an object, interest, and other users in the social networking system 100 based on the actions performed by the user. Multiple interactions between a user and a specific object may be stored in one edge object in the edge store 214, in one embodiment. For example, a user that plays multiple songs from Lady Gaga's album, “Born This Way,” may have multiple edge objects for the songs, but only one edge object for Lady Gaga.

An ad targeting module 108 may generate targeting criteria for advertisements embodied in ad objects 118 that are stored in the ad store 210. Targeting criteria may be received from advertisers through a user interface on the social networking system 100, in one embodiment. In another embodiment, targeting criteria may be received from advertisers through a series of communications with the ad targeting module 108. For example, an advertisement for a local offer on photography classes may be targeted to users that have recently uploaded photos to the social networking system 100. In one embodiment, as a user 106 is uploading a photo, a content object 104, to the social networking system 100, the advertisement for photography classes, an ad object 118a, may be provided for display to the user because the ad targeting module 108 may have been configured to target ads to users that are currently uploading photos. As the user 106 uploads photos, the social networking system 100 may generate edge objects 116 representing the user interactions by the user 106. By enabling advertisers to dynamically target advertisements to users as actions are being performed on the social networking system 100, advertisers may provide more relevant and timely advertisements to users. The dynamic actions performed by user 106 are analyzed, filtered and inserted into the edge store 214 in real time. The ad targeting module 108 automatically includes the new users performing the given actions and delivers the targeted ad objects 118 for display. In one embodiment, applications that enable users to perform actions on objects may also be targeted by advertisers. Returning to the example above, a user 106 may upload photos to an external system using an application installed on the social networking system 100 that was developed by a third-party. Advertisers may target advertisements to actions performed on objects through specific applications, in one embodiment.

In one embodiment, advertisers may include multiple targeting criteria based on interactions performed by users of the social networking system 100. For example, an advertiser may target users that performed the “listen” action on the “Lady Gaga” object but that did not perform the “purchase” action on the “Born This Way” object. In this way, multiple types of interactions may be used for targeting advertisements, and conditional targeting, both positive and negative, may also be used in targeting criteria.

### Targeting Ads Based on Edge Types on a Social Networking System

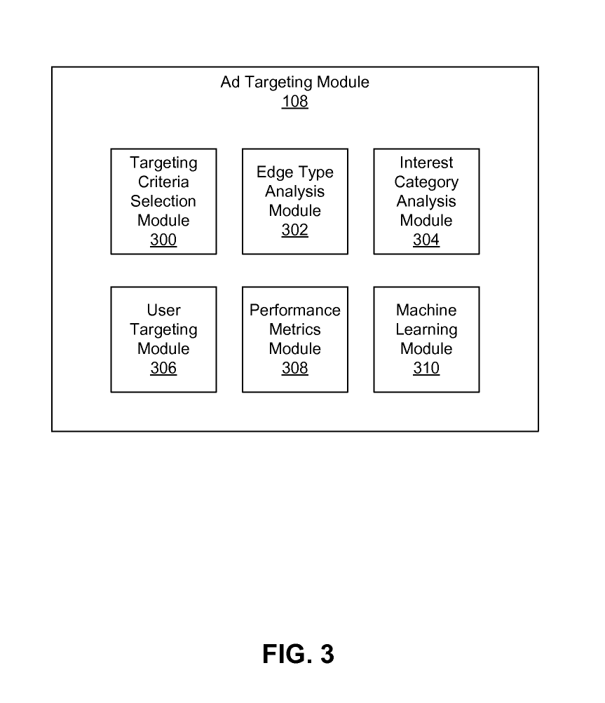

FIG. 3 illustrates a high level block diagram of the ad targeting module 108 in further detail, in one embodiment. The ad targeting module 108 includes a targeting criteria selection module 300, an edge type analysis module 302, an interest category analysis module 304, a user targeting module 306, a performance metrics module 308, and a machine learning module 310. These modules may perform in conjunction with each other or independently to develop a match scoring model of matching pages on a social networking system 100.

A targeting criteria selection module 300 enables advertisers to select targeting criteria for their advertisements. In one embodiment, the social networking system 100 enables less sophisticated advertisers to select targeting criteria via a user interface. The targeting criteria selection module 300 receives selections of targeting criteria, such as demographic information, geographic location information, types of actions performed by users, and keywords associated with the objects upon which the actions were performed. In another embodiment, the targeting criteria selection module 300 receives selected targeting criteria from sophisticated advertisers that communicate with the social networking system 100 through application programming interfaces (APIs). Sophisticated advertisers may be provided access to edge object information to enable them to specify detailed targeting criteria, such as a predetermined threshold number of actions having a particular action type performed on object having a particular object property using APIs. For example, a sophisticated advertiser may specify that an advertisement be targeted to a user that has performed at least 5 check-in events at a Starbucks Coffee shop. In one embodiment, a social networking system 100 may provide a user interface for less sophisticated advertisers to specify a predetermined threshold number of actions having a particular action type performed on object having a particular object property. In another embodiment, an advertiser may want to know the frequency distribution of edges for a particular object and target users based on that distribution. For example, the advertiser may use the edge API module to query the social networking system 100 for the frequency distribution of users listening to Lady Gaga over a 30 day period. Based on this frequency distribution, the advertiser may want to target only users who fall within the top quartile to capture avid Lady Gaga fans. As a result, the targeting criteria for an advertisement may include a targeted percentile in a frequency distribution of the one or more targeted action types.

An edge type analysis module 302 retrieves edge objects 116 based on received targeting criteria for targeting advertisements. In one embodiment, the edge type analysis module 302 aggregates edge objects 116 based on a specified edge type in the received targeting criteria. For example, targeting criteria may include a rule to target an advertisement based on a user performing a predetermined threshold number of actions on objects having a common object property, such as more than 5 check-in events at real-world business locations that are identified as bars. In this example, the edge type is a check-in event, and the object property is a bar.

In another embodiment, the edge type analysis module 302 may be used to identify actions that may be relevant to the targeting criteria of an advertisement. For example, an ad targeting module 108 may receive a keyword, such as “Glee,” but may not receive edge type targeting criteria because the advertiser may want to discover what type of actions related to “Glee” are popular and relevant on the social networking system. The edge type analysis module 302 may retrieve edge types that are associated with the page object for “Glee,” as well as other objects associated with “Glee,” such as music albums, artists, movies, concert tours, merchandise, fan groups, and the like. As a result, new edge types may be discovered by the advertiser. For example, a new gaming application may enable users to “perform” their favorite songs from Glee in a karaoke-type application. Thus, the new graph action type of “perform” may be discovered as an action type that can be targeted by the advertiser. Other graph action types, stored in the social networking system 100 as edge types, may discovered in a similar manner, such as “wants,” “watched,” “played,” “listened,” “read,” “attended,” “purchased,” “joined,” “shared,” “recommended,” “voted,” “reviewed,” “RSVP'd,” “messaged,” “chatted,” “emailed,” and “liked.” The actions for each edge type may be aggregated for each user, enabling the advertiser to gauge which edge types are more popular with certain demographics, and which edge types are popular across all users of the social networking system. In this way, advertisers may target users that have performed custom actions related to their products, even if they were unaware of the custom action types.

In a further embodiment, the edge type analysis module 302 may be used in conjunction with the targeting criteria selection module 300 to select multiple edge types for targeting criteria of an advertisement. For example, a “super fan” may watch multiple videos, purchase concert tickets, and share blog posts about a celebrity, such as “Britney Spears.” Marketers for a new fragrance by Britney Spears may wish to target super fans, or users that match a profile of multiple action types performed on objects associated with the brand. Using the edge type analysis 302, sophisticated advertisers may configure rules with multiple edge types for selecting targeting criteria for advertisements. In one embodiment, the edge type analysis may be included in the advertisement targeted to a user of the social networking system 100. For example, an advertisement for the Britney Spears Fragrance may include information about edges that caused the ad to be targeted to the user, such as “You've listened to songs by Britney Spears 15 times.” Exposing the edge type analysis in the advertisement provides useful information to the user viewing the advertisement. In another embodiment, the advertisement may include the specific targeting criteria used to target the user within the advertisement, such as “You are receiving this advertisement because you have listened to songs by Britney Spears 15 times.” As a result, the advertisement may be more persuasive to the user because the inclusion of the reason why the advertisement was targeted to the user is linked to actions performed by the user within the social networking system.

As described above, users of a social networking system 100 may provide a rich set of data that enables advertisers and administrators of the social networking system to gain a deep understanding of the kinds of concepts, products, brands, places, and people that users are interested in. Users may be categorized by an interest category analysis module 304 for users of the social networking system 100. For example, a user may perform a “want” action on a product, such as a new computer, on third-party e-commerce retailer website. This “want” action performed on an object representing the new computer may be communicated to the social networking system 100. Similarly, the user may “share” a consumer reports article about the same computer with other users of the social networking system connected to the user. The user may then “watch” a keynote speech about the new computer and “comment” on a page post about the new computer. Finally, the user may “purchase” the new computer and “post” a status message with the name of the new computer. These actions may be received by the social networking system as custom actions.

Administrators of the social networking system and advertisers may wish to identify these types of users, or “early adopters,” that are prone to purchasing new technology as soon as it comes out. These users may be categorized by analyzing edge objects associated with technology, such as the new computer. Other types of categories may be defined by advertisers and administrators of the social networking system 100 based on an analysis of the edge information available on the social networking system 100, such as users that execute check-in events at multiple bars after 10 pm, users that perform actions that are related to musicals, and users that are Lady Gaga fans, for example. These categories may be reused by other advertisers, in one embodiment. As a result, interest categories may be used to target users that perform actions having pre-selected action types.

A user targeting module 306 identifies users for targeting advertisements based on the selected targeting criteria, edge type analysis, and interest category analysis performed by the ad targeting module 108. In one embodiment, edge objects 116 are retrieved based on the targeting criteria. Based on edge type analysis, such as aggregating actions of a particular edge type for a user, users are identified for targeting the advertisements. Other information about users, such as demographic information, location information, and other attributes of users, may be used by the user targeting module 306 in selecting users to target advertisements. In another embodiment, interest category analysis may be used in selecting users for targeting advertisements, such as users that have been categorized as “early adopters,” or users that have been categorized as “Lady Gaga fans.”

A performance metrics module 308 may be used to analyze performance metrics of targeted advertisements, such as conversion rates and user feedback. This information may be used in adjusting rules and predetermined thresholds used in the edge type analysis module 302. For example, an advertisement may be targeted to a user based on the user performing a predetermined threshold number of actions on objects having a specified object property, such as 5 check-in events at coffee shops. The user may provide user feedback that the advertisement for Starbucks is irrelevant because the user is not interested in Starbucks. The targeting criteria may then be adjusted to add a rule to check if the user does not have an interest in Starbucks, for example. Other performance metrics, such as engagement with the advertisement measured via click-through rates and application installations, may be used to adjust rules and predetermined thresholds.

In one embodiment, conversion metrics, as defined by a subset of edge types specified by the advertiser, may be used to adjust rules and predetermined thresholds targeting criteria. For example, a record label may consider a user who “listens to Lady Gaga on Spotify” as a conversion event because the application being used to listened to the music, Spotify, receives revenue for advertisements that are played in between song plays. As a result, an advertiser associated with Spotify may adjust thresholds in targeting criteria because a user that listens to more songs may be more likely to purchase a premium subscription. In another embodiment, a clearing price for a particular interaction performed by users may be used as a metric to adjust rules and predetermined thresholds for targeting criteria. For example, if a subset of users is expensive relative to another set of users, then the clearing price for that subset of users may be used to adjust rules and predetermined thresholds for targeting criteria as selected by advertisers. Sophisticated advertisers may optimize the cost per action (CPA), or conversion, such that if the audience being targeted exceeds their cost per action, then the advertisers may target different sets of users based on different targeting criteria.

A machine learning module 310 may be used in the ad targeting module 108 to refine predetermined thresholds and rules for targeting advertisements based on edge information. In one embodiment, a social networking system 100 uses a machine learning algorithm to analyze user feedback received to retrain the predetermined thresholds and rules for selected targeting criteria. In another embodiment, a machine learning algorithm may be used to optimize predetermined thresholds to maximize engagement and conversion rates of advertisements.

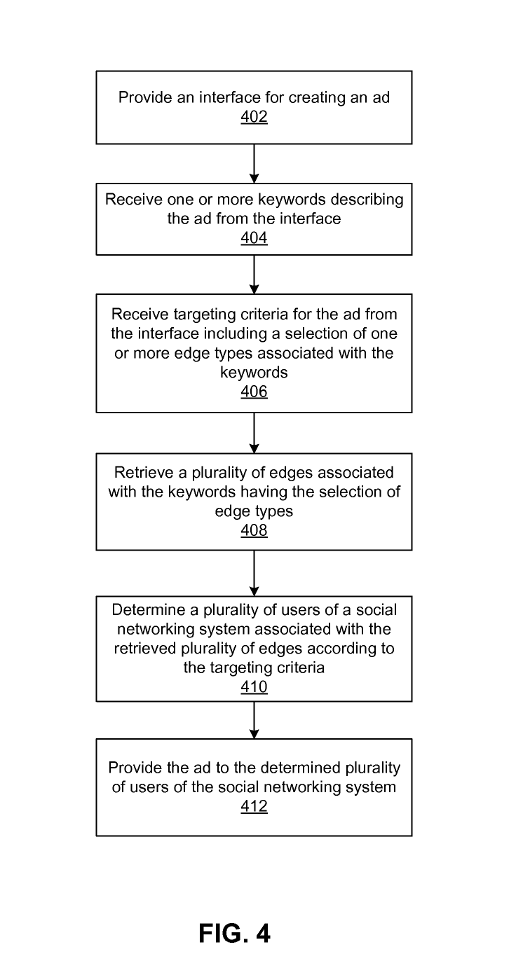

FIG. 4 illustrates a flow chart diagram depicting a process of targeting advertisements to users of a social networking system based on user interactions, in accordance with an embodiment of the invention. An interface for creating an ad is provided 402. The interface may be a user interface, in one embodiment, for less sophisticated advertisers to create an advertisement. In another embodiment, a communications interface with the social networking system 100 may be provided 402 in which a sophisticated advertiser may create an advertisement through a series of application programming interface (API) calls.

One or more keywords describing the ad are received 404 from the interface. For example, a keyword phrase such as “coffee shop” may be received 404 from the interface. Targeting criteria for the ad is received 406 from the interface, including a selection of one or more edge types associated with the keywords. Continuing the example, an advertiser may select targeting criteria such as demographics, locations, and edge types associated with the keyword phrase “coffee shop,” such as “drinking,” “reading,” “is at,” and “likes.” Advertisers may select any type of edge for targeting in addition to keywords, demographics, objects, applications, and the like.

After targeting criteria for the ad that includes a selection of one or more edge types associated with the keywords are received 406, a plurality of edges associated with the keywords having the selection of edge types are retrieved 408. A plurality of users of a social networking system associated with the retrieved plurality of edges are determined 410 according to the targeting criteria. For example, an advertiser may target users that have completed an action more than a predetermined threshold number of times, such as 5 check-in events at a coffee shop. In this way, retrieved edges are aggregated by user to determine 410 a plurality of users to target the advertisement. After the plurality of users are determined 410, the ad is provided 412 to the determined plurality of users of the social networking system.

### Determining Interest Categories Based on Edge Information in a Social Networking System

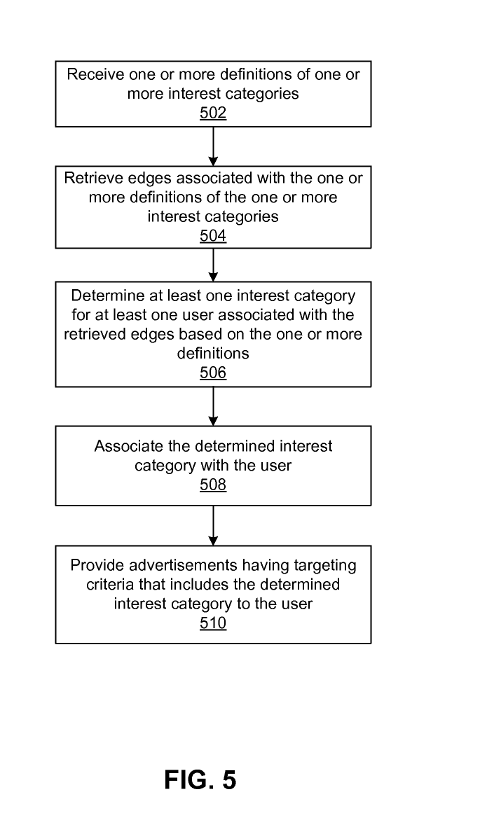

FIG. 5 illustrates a flow chart diagram depicting a process of targeting advertisements to users of a social networking system based on interest categories determined from edges associated with the users, in accordance with an embodiment of the invention. Definitions of one or more interest categories are received 502. For example, an advertiser may define an interest category of “early adopters” to be users that have shared links about technology and have performed a “want” action on an object that has an object property of technology. Definitions may be received 502 via a user interface, in one embodiment. In another embodiment, definitions may be pre-defined by administrators of the social networking system 100. In a further embodiment, sophisticated advertisers may create definitions independent of the social networking system 100 and communicate the definitions via a communications interface with the social networking system 100, such as API calls.

After the definitions of the one or more interest categories are received 502, edges associated with the definitions of the one or more interest categories are retrieved 504. The social networking system 100 may employ fuzzy matching techniques, such as recognizing misspellings of words, expanding words based on a root word, and using a thesaurus database to retrieve 504 edges that are associated with the definitions, in one embodiment. In another embodiment, interest categories are defined using keywords maintained by the social networking system 100. Edges may then be retrieved 504 based on whether the edges include keywords that are used in the definitions of the interest categories. For example, an advertiser for a GAP jeans ad campaign may select keywords describing jeans and tacos to advertise a taco truck sponsored by GAP. Interest categories may already exist that include the keywords separately, such as “Mexican food aficionados” and “shopaholics.” As a result, the advertisement for the taco truck sponsored by GAP may be associated with the definitions for “Mexican food aficionados” and “shopaholics.” Edges would then be retrieved 504 based on whether the edges include keywords that are used in the definitions of the interest categories, which may include other keywords, such as “burrito,” “nachos,” “shirts,” and “sales.”

At least one interest category for at least one user associated with the retrieved edges may be determined 506 based on the definitions. Returning to a previous example, an “early adopter” interest category may be determined for a user that is associated with retrieved edges that are associated with technology. In one embodiment, the retrieved edges may be analyzed to match edge types that are listed in the definitions of the interest categories and match object properties that are listed in the definitions. A user that performed actions such as commenting on a technology blog post, sharing links of articles dedicated to technology, and creating check-in events at technology conferences may be determined 506 to be in an “early adopter” interest category, for example, if the definition of an “early adopter” including performing actions on objects relating to technology. In another embodiment, definitions of the one or more interest categories may specify a predetermined threshold number of actions of a particular action type, or a predetermined threshold number of actions of any action type over a given time period. In this way, advertisers may adjust the rules and definitions of interest categories based on performance metrics.

Once an interest category has been determined 506 for at least one user associated with the retrieved edges based on the definitions, the determined interest category may be associated 508 with the user. In one embodiment, the determined interest category may be associated with a user profile object associated with the user. In another embodiment, the determined interest category may be stored as an object in the social networking system 100 and may list identifying information about the user, such as a user identifier, in the object for the interest category.

After the determined interest category has been associated 508 with the user, advertisements having targeting criteria that includes the determined interest category may be provided 510 to the user. In one embodiment, advertisements may be provided 510 to the user within the social networking system 100. In another embodiment, advertisements may be provided 510 to the user on systems external to the social networking system 100, such as external websites and mobile applications not connected to the social networking system 100.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
maintaining a plurality of edge objects on a social networking system, the plurality of edge objects representing a plurality of actions having a plurality of action types, the plurality of actions performed on a plurality of objects by a plurality of users of the social networking system;
receiving targeting criteria for an advertisement, the targeting criteria including one or more targeted action types and at least one targeted object property of the plurality of objects;
retrieving a subset of the plurality of edge objects based on the targeting criteria, the subset of the plurality of edge objects representing a subset of the plurality of actions having the one or more targeted action types and associated with objects having the at least one targeted object property;
determining a targeting cluster of users comprising a subset of the plurality of users of the social networking system associated with the subset of the plurality of edge objects based on the targeting criteria; and
for a viewing user, providing the advertisement for display to the viewing user based on the viewing user being in the targeting cluster of users.

2. The method of claim 1, wherein the targeting criteria further comprises a predetermined threshold number of actions having the one or more targeted action types, and wherein determining a subset of the plurality of users of the social networking system associated with the subset of the plurality of edge objects based on the targeting criteria further comprises:
determining the subset of the plurality of users that have performed the predetermined threshold number of actions based on the subset of the plurality of edge objects.

3. The method of claim 1, wherein receiving targeting criteria for an advertisement further comprises:
receiving a selection of targeting criteria for the advertisement from a user interface, the user interface including the plurality of action types and the targeting criteria including a subset of the plurality of action types and the at least one object property.

4. The method of claim 1, wherein receiving targeting criteria for an advertisement further comprises:
receiving the targeting criteria for the advertisement from an application programming interface (API) call, the API call including the targeting criteria.

5. The method of claim 4, wherein the API call further comprises at least one filter regarding edge information as part of the targeting criteria.

6. The method of claim 1, wherein providing the advertisement for display to the viewing user based on the viewing user being in the targeting cluster of users further comprises:
providing, within the advertisement, an information item about an edge object having the one or more targeted action types associated with the viewing user.

7. The method of claim 6, wherein the information item about an edge object having the targeted action type associated with the viewing user comprises an aggregation of a subset of the plurality of actions associated with the edge object.

8. The method of claim 1, wherein the at least one targeted object property of the plurality of objects comprises a geographic location.

9. The method of claim 1, wherein the at least one targeted object property of the plurality of objects comprises a property of a graph object type defined by an entity external to the social networking system.

10. The method of claim 1, wherein providing the advertisement for display to the viewing user based on the viewing user being in the targeting cluster of users further comprises:
responsive to receiving an indication of a new edge object generated for a new interaction having the targeted action type by the viewing user, providing, within the advertisement, an updated information item about the new edge object.

11. The method of claim 1, wherein targeting criteria for an advertisement further includes a specified node in the social networking system.

12. The method of claim 1, wherein the one or more targeted action types include a graph action type defined by an entity external to the social networking system.

13. The method of claim 1, wherein providing the advertisement for display to the viewing user based on the viewing user being in the targeting cluster of users further comprises:
responsive to determining that an edge object of the subset of the plurality of edge objects was recently generated by the viewing user, dynamically providing the advertisement to the viewing user in real-time.

14. The method of claim 1, wherein retrieving a subset of the plurality of edge objects based on the targeting criteria further comprises:
retrieving a first plurality of edge objects associated with a first plurality of objects having the targeted object property;
providing the first plurality of edge objects to an advertiser for selection of one or more targeted action types;
responsive to receiving one or more selected targeted action types from the advertiser, retrieving a second plurality of edge objects associated with the one or more selected targeted action types associated with a second plurality of objects having the targeted object property; and
determining the subset of the plurality of the edge objects as the second plurality of edge objects.

15. The method of claim 1, wherein the targeting criteria further comprises a targeted application and wherein retrieving a subset of the plurality of edge objects based on the targeting criteria further comprises:
retrieving the subset of the plurality of edge objects representing the subset of the plurality of actions generated by the subset of the plurality of users using the targeted application.

16. The method of claim 1, wherein the targeting criteria further comprises a targeted percentile in a frequency distribution and wherein determining a targeting cluster of users comprising a subset of the plurality of users of the social networking system associated with the subset of the plurality of edge objects based on the targeting criteria further comprises:
determining the frequency distribution of the subset of the plurality of actions having the one or more targeted action types among the subset of the plurality of users; and
determining the targeting cluster of users based on the targeted percentile in the frequency distribution.

17. The method of claim 1, wherein the targeting criteria further comprises a negative conditional targeting criterion and wherein retrieving a subset of the plurality of edge objects based on the targeting criteria further comprises:
determining the subset of the plurality of edge objects representing the subset of the plurality of actions having the one or more targeted action types based on the negative conditional targeting criterion.

18. A method comprising:
storing at a social networking system a plurality of graph objects interconnected by graph actions, the graph actions having graph action types defined by entities external to the social networking system, where a graph action represents a relationship between two or more graph objects and the graph action type defines the relationship between the two or more graph objects;
maintaining a plurality of edge objects having a plurality of edge types on the social networking system, where a subset of the plurality of edge objects have graph action types associated with the plurality of graph actions;
receiving targeting criteria for an advertisement, the targeting criteria including a targeted graph action type and at least one targeted object property;
retrieving a subset of the plurality of edge objects based on the targeting criteria, the subset of the plurality of edge objects having the targeted graph action type and the subset of the plurality of edge object associated with a subset of the plurality of graph objects having the at least one targeted object property;
determining a subset of the plurality of users of the social networking system associated with the subset of the plurality of edge objects; and
providing the advertisement for display to the subset of the plurality of users of the social networking system.

19. The method of claim 18, wherein the targeting criteria is received from an entity of the entities external to the social networking system.

20. The method of claim 18, wherein the targeting criteria is received from a user interface provided to an advertiser to select the targeting criteria.

21. The method of claim 18, wherein the targeting criteria is received from an advertiser communicating with the social networking system via an application programming interface (API) call, where the API call includes the targeting criteria.

22. The method of claim 21, wherein determining a subset of the plurality of users of the social networking system associated with the subset of the plurality of edge objects further comprises:
identifying targeted users of the social networking system that performed graph actions having the targeted graph action type on an external system associated with the advertiser based on the retrieved subset of the plurality of edge objects; and
determining the targeted users as the subset of the plurality of users.

23. A method comprising:
maintaining a plurality of edge objects having a plurality of edge types on a social networking system, the plurality of edge objects representing a plurality of actions performed by a plurality of users of the social networking system on a plurality of objects;
receiving one or more definitions of one or more interest categories, where each definition includes at least one edge type;
retrieving a subset of the plurality of edge objects based on each edge object of the subset of the plurality of edge objects having an edge type matching the at least one edge type in the one or more definitions;
determining, based on the one or more definitions, at least one interest category for at least one user of the social networking system associated with the retrieved subset of the plurality of edge objects; and
associating the at least one interest category with the at least one user.

24. The method of claim 23, wherein receiving one or more definitions of one or more interest categories, where each definition includes at least one edge type, further comprises:
receiving the one or more definitions of the one or more interest categories from an application programming interface (API) call, the API call including the one or more definitions of the one or more interest categories.

25. The method of claim 23, wherein receiving one or more definitions of one or more interest categories, where each definition includes at least one edge type, further comprises:
receiving a selection of the one or more definitions of the one or more interest categories from a user interface, the user interface including the plurality of edge types.

26. The method of claim 23, wherein determining, based on the one or more definitions, at least one interest category for at least one user of the social networking system associated with the retrieved subset of the plurality of edge objects further comprises:
aggregating actions for users by edge type based on the retrieved subset of the plurality of edge objects; and
determining at least one user satisfying one or more definitions of the one or more interest categories based on the aggregated actions for the at least one user.

27. The method of claim 23, wherein determining, based on the one or more definitions, at least one interest category for at least one user of the social networking system associated with the retrieved subset of the plurality of edge objects further comprises:
identifying edge types of actions performed for each user associated with the retrieved subset of the plurality of edge objects; and
determining at least one user satisfying one or more definitions of the one or more interest categories based on the identified edge types of actions performed by the at least one user.

28. The method of claim 23, wherein associating the at least one interest category with the at least one user further comprises:
storing in a user profile object of the social networking system associated with the at least one user an indication of the at least one interest category.

29. The method of claim 23, wherein associating the at least one interest category with the at least one user further comprises:
storing in a content object of the social networking system associated with the at least one interest category identifying information about the at least one user.

30. The method of claim 23, further comprising:
providing an advertisement for display to the at least one user, the advertisement having targeting criteria that includes the at least one interest category.

31. The method of claim 23, wherein receiving one or more definitions of one or more interest categories, where each definition includes at least one edge type, further comprises:
maintaining a plurality of definitions of a plurality of interest categories previously received by the social networking system; and
receiving a selection of the one or more definitions of the one or more interest categories from the maintained plurality of definitions of the plurality of interest categories previously received by the social networking system.

32. The method of claim 31, wherein maintaining a plurality of definitions of a plurality of interest categories previously received by the social networking system, further comprises:
maintaining a plurality of keywords previously received by the social networking system, the plurality of keywords associated with the plurality of objects in the social networking system; and
associating the plurality of keywords with the plurality of interest categories received by the social networking system based on the plurality of definitions, where each definition includes a keyword.
